(19) United States
(12) Patent Application Publication
(10) Pub. No.: US 2025/0243901 A1
(43) Pub. Date: Jul. 31, 2025

(54) AERODYNAMIC BEARING FOR AXIAL AND/OR RADIAL MOUNTING OF A SHAFT AS WELL AS METHODS OF MANUFACTURE OF SUCH A BEARING

(71) Applicant: ebm-papst Mulfingen GmbH & Co. KG, Mulfingen (DE)

(72) Inventor: Mihai B. DOBRICA, Heidelberg (DE)

(21) Appl. No.: 19/041,917

(22) Filed: Jan. 30, 2025

(30) Foreign Application Priority Data
Jan. 31, 2024 (DE) 102024102699.5

(51) Int. Cl. F16C 32/06

(52) U.S. Cl. CPC F16C 32/0607; F16C 2360/24

(57) ABSTRACT

An aerodynamic bearing for axial and/or radial mounting of a shaft for a turbocompressor extending along an axis of rotation, wherein the aerodynamic bearing has a first bearing part denotable as a rotor, and a second bearing part denotable as a stator with respect to which the first bearing part is rotatable about the axis of rotation. The first bearing part and/or the second bearing part have a bearing surface facing the respective other bearing part and on which an air cushion for aerodynamic mounting is generatable between the bearing parts. The bearing surface has a plurality of depressions, each following a predetermined longitudinal profile on the bearing surface and arranged to form a predetermined pattern. The depressions each have, over their respective longitudinal profiles on the bearing surface, a varying depth which is determined by a depth profile restricted to a predetermined number of depth levels.

### RELATED APPLICATIONS

This application claims priority to German Patent Application No. 10 2024 102 699.5, filed Jan. 31, 2024, the entire contents of which is incorporated herein by reference in its entirety.

### FIELD

The disclosure relates to an aerodynamic bearing for axial and/or radial mounting of a shaft extending along an axis of rotation, as well as to methods of manufacture of such a bearing.

### BACKGROUND

Aerodynamic bearings, which may also be referred to as gas or air bearings, respectively, have been known in the prior art for a long time. In this regard, a gas or air cushion, respectively, is built up as a lubricant between two bearing partners or bearing surfaces provided by them, respectively, so that the bearing partners or bearing parts, respectively, can rotate relative to one another essentially without any contact or friction.

In order to increase the stability or the maximum possible rotational speeds with the bearing, respectively, it has also been known for a long time to introduce depressions into the bearing surfaces, by means of which the air cushion remains consistent and loadable, in particular at high rotational speeds, so that even at high rotational speeds or high loading of the bearing, a pressure distribution required for mounting is maintained on the bearing surfaces.

In thrust bearings, the depressions can be formed, for example, in a spiral-like fashion, and in radial bearings, for example, in an arrow-like fashion, and can each be arranged to form a herringbone pattern, so that mutually adjacent depressions engage one another in a non-contacting manner.

We have found from experiments and calculations that it is further advantageous for the depressions to have a varying depth along their respective profile, and it has been found that using conventional methods of manufacture, such as, for example, lasers, a continuous or step-free, respectively, depth profile can only be manufactured in a complex manner.

### BRIEF SUMMARY

The present disclosure overcomes the above-mentioned disadvantages and provides an aerodynamic bearing which is simple to manufacture and makes high rotational speeds achievable.

According to the disclosure, an aerodynamic bearing for axial and/or radial mounting of a shaft for a turbocompressor, which may preferably be a high-speed turbocompressor, extending along an axis of rotation is thus proposed. In this regard, the turbocompressor may be formed as a radial, axial, or diagonal compressor. The features explained in the following may also relate to a thrust bearing, however, they preferably relate to a radial bearing. Correspondingly, the aerodynamic bearing has a first bearing part (rotatable with the shaft or integrally formed by the shaft) denotable as a rotor, and a second bearing part denotable as a stator with respect to which the first bearing part is rotatable about the axis of rotation. In the case of a thrust bearing, the bearing parts are preferably formed as bearing rings adjacent to one another, one bearing ring of which being fixed to the shaft in the manner of a sleeve or flange, respectively. In the case of a radial bearing, one of the bearing parts extends in the circumferential direction around the shaft and is preferably formed integrally by the shaft, the other bearing part revolving around the shaft and formed in the shape of a hollow cylinder. Regardless of whether it is formed as a thrust bearing or a radial bearing, it is therefore provided in each case that the first bearing part and/or the second bearing part have a bearing surface facing the respective other bearing part and on which an air cushion or gas cushion, respectively, for aerodynamic mounting is generatable between the bearing parts, which due to its low thickness is also denotable, for example, as an air or gas film, respectively. For ease of differentiation, in the following, the bearing surfaces may also be referred to as a rotor bearing surface and a stator bearing surface. Further, the bearing surface has, or both bearing surfaces have, respectively, a plurality of depressions, each following a predetermined longitudinal profile on the bearing surface and arranged to form a predetermined pattern. In this regard, due to their predetermined longitudinal profiles, the depressions may each also be referred to, for example, as a channel or groove. According to the disclosure, the depressions each have, over their respective longitudinal profiles on the bearing surface, a depth varying relative to the bearing surface which is determined by a depth profile restricted to a predetermined and limited or finite, respectively, number of, in particular discrete, depth levels.

The proposed depth profile may therefore be described as a discrete depth profile in contrast to a depth profile denotable as a continuous depth profile having an unlimited number of (infinite) depth levels.

By restricting the depth profile to a predetermined number of predetermined depth levels, manufacture is significantly simplified, so that such a bearing can be manufactured and provided in a simple manner.

In this regard, the depth profile may run in three to twelve, in particular four to ten, depth levels or the number of depth levels may be restricted to three to twelve or four to ten, respectively.

In this regard, a respective transition between the depth levels occurs in a comparatively flat manner and correspondingly at an angle of less than 34°, more preferably the angle being between 2° and 20°.

The transition between the depth levels preferably possesses a length of between 10 and 100 μm, in particular between 40 and 60 μm and further in particular 50um, with the individual depth levels or their profiles between two transitions, respectively, preferably having a length of between 1 and 20 μm, further preferably between 2 and 10 μm.

As further explained in the context of the proposed manufacturing methods, the depth profile according to the disclosure may be a native discrete depth profile or a discrete depth profile as an approximation to a continuous depth profile.

In this regard, relating to their depth, immediately adjacent depth levels may have a distance of between 1 and 20 μm, in particular 2 and 10 μm, from one another, wherein the distances between the various depth levels may be different, so that the increments achieved by the depth levels may as a result be irregular.

In order to be able to generate an optimal pressure distribution, in particular in the case of asymmetrical load distribution, it may also be provided that the depth profile is symmetrical or asymmetrical with respect to a centre of the longitudinal profile formed, for example, by an apex.

Although the depth profiles of the depressions may in principle be different, it is preferably provided that the depth profiles of all the depressions are the same.

Furthermore, it is to be noted that the respective longitudinal profile or the longitudinal profiles of the depressions, respectively, may consist exclusively of rectilinear sections or may be curved at least in sections.

In this regard, the longitudinal profile may form one arrow shape each, so that the depressions each have two sections connected via a bend.

Further, the depressions may each have, over their respective longitudinal profiles on the bearing surface, a uniform or varying width, wherein it has to be noted that a continuous, i.e., step-free or increment-free, respectively, variation of the width is usually possible without any issues thanks to modern methods of manufacture and, for example, lasers, other than a variation of the depth.

As already mentioned, the depressions are preferably arranged to form a herringbone pattern, with this preferably understood to mean that the depressions overlap at least in sections in a predetermined direction of rotation and, in the case of a radial bearing, in the circumferential direction about the axis of rotation and thus engage one another without any contact.

A further aspect of the disclosure herein relates to a method of manufacture of an aerodynamic bearing proposed according to the disclosure. By simulation and/or calculation, for example using numerical calculation methods or the finite difference method, a continuous depth profile is first determined for an optimal pressure distribution on the bearing surface at a maximum rotational speed. Subsequently, the continuous profile, which is usually impossible or difficult to manufacture, is approximated by interpolation or approximation using the depth profile restricted to the predetermined number of depth levels.

As an alternative to this determination of the discrete depth profile via the continuous depth profile, the discrete depth profile may also be determined natively, i.e., by already taking into account during the simulation and/or calculation, for example using numerical calculation methods or the finite difference method, that the depth profile is restricted to the predetermined number of depth levels, so that the depth profile, which is restricted to the predetermined number of depth levels, is determined natively, i.e., immediately, for an optimal pressure distribution on the bearing surface at a maximum rotational speed.

The features disclosed above can be combined as required, provided this is technically possible and they do not contradict one another.

### BRIEF DESCRIPTION OF THE DRAWINGS

Other advantageous developments of the disclosure are characterized in the subclaims and/or depicted in greater detail below together with the description of the preferred embodiment of the disclosure with reference to the figures. In the drawings:

FIG. 1 shows an aerodynamic bearing formed as a radial bearing;

FIG. 2 shows a depth profile of the depressions of the bearing according to FIG. 1.

### DETAILED DESCRIPTION

The figures are schematic examples. Same reference symbols in the figures indicate same functional and/or structural features.

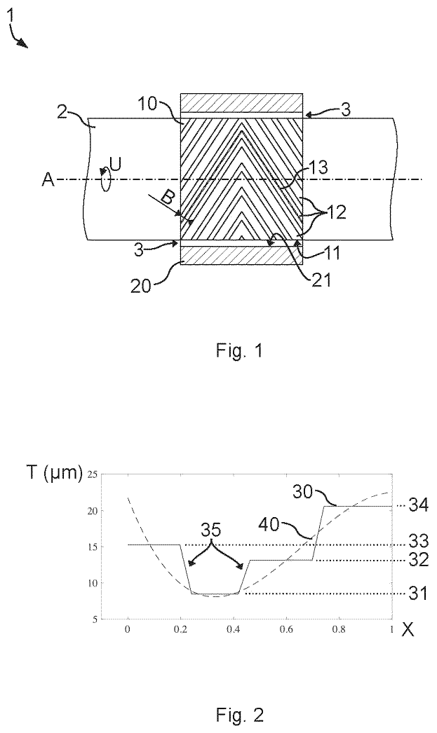

FIG. 1 shows an aerodynamic bearing 1 for radial mounting of a shaft 2 extending along the axis of rotation A, which may correspondingly also be referred to as a radial bearing 1 and is provided in particular for usage in a high-speed turbocompressor.

Correspondingly, the bearing 1 has two bearing partners or two bearing parts 10, 20, respectively. The first bearing part 10 is formed as a rotor integral with the shaft 2 and is correspondingly rotatable about the axis of rotation A. The second bearing part 20 is formed as a stator and surrounds the first bearing part 10 completely as well as annularly in the circumferential direction U, so that the second bearing part 20 depicted in section in FIG. 1 essentially corresponds to a hollow cylinder.

The bearing parts 10, 20 have one bearing surface 11, 21 each which face one another, so that, upon rotation of the first bearing part 10 between the bearing surfaces 11, 21, an air or gas cushion 3, respectively, is formed which serves as a lubricant or slip agent, respectively, for mounting.

In order to achieve an optimized pressure distribution of the lubricating medium, i.e., of the gas or of the air, respectively, at the bearing surface 11 of the first bearing part 10 or at the rotor bearing surface 11 of the rotor 10, respectively, even at high rotational speeds, a plurality of depressions 12 are provided on the first bearing surface 11, each of which extends in an arrow shape along a longitudinal profile 13. Correspondingly, the respective identical longitudinal profiles 13 of the depressions 12 each have two rectilinear sections which are connected to one another by a bend or an apex, respectively.

As can be clearly seen in FIG. 1, the arrow-shaped depressions 12 overlap in the circumferential direction U, thus resulting in a pattern similar to a herringbone pattern.

Although the depressions 12 are presently depicted with a uniform width B, with the exception of the peripheral or bent regions, respectively, the width B may also vary over the longitudinal profile 13.

Apart from the width B and the longitudinal profile 13, the pressure distribution on the bearing surface 11 is also influenced, in particular, by the depth T of the depression 12, wherein it has become evident that this in particular can optimize the pressure distribution of the air or of the gas, respectively, in the pressure cushion 3, and correspondingly higher rotational speeds can be achieved if the depth T of the depression 12 does not remain constant over its longitudinal profile 13, but is varied.

By simulation and/or calculation, a depth profile can be determined for the variation of the depth T, by means of which the depth T of the depression 12 along the longitudinal profile 13 is specified for the intended optimized pressure distribution on the first bearing surface 11.

However, if this depth profile is determined as a continuously changing profile, i.e., a profile denotable as a continuous depth profile 40, it is difficult or impossible to manufacture.

Therefore, according to the disclosure, the variation of the depth is restricted to certain depth levels 31, 32, 33, 34, so that the depth T can essentially only assume the values determined by the depth levels 31, 32, 33, 34. This results in a depth profile 30 restricted to a predetermined number of depth levels 31, 32, 33, 34 which is also denotable as a discrete depth profile 30.

In FIG. 2, both a continuous depth profile 40 and a discrete depth profile 30 are plotted over a longitudinal profile 13 of a depression 12, wherein the position X along the longitudinal profile 13 is given without any dimensions, so that 0 corresponds to a starting point of the longitudinal profile 13, and 1 corresponds to an end point or apex of the longitudinal profile 13.

In principle, the depth profile 30 restricted to the predetermined number of depth levels 31, 32, 33, 34 may be determined on the basis of a previously determined continuous depth profile 40, so that the discrete depth profile 30 corresponds to an approximation of the continuous depth profile 40.

Alternatively, the calculation or simulation, respectively, for the determination of the optimal profile of the depth T may immediately take into account that the depth T may only assume or possess, respectively, the predetermined depth levels 31, 32, 33, 34, so that the discrete depth profile 30 occurs immediately or natively, respectively, and without any preceding determination of a continuous depth profile 40.

FIG. 2 also demonstrates an asymmetry of the depth profile 30, by means of which, for example, a likewise asymmetrical load distribution on the bearing 1 may be taken into account.

Independently of this, it must be taken into account that, due to the usable production methods, between the individual depth levels 31, 32, 33, 34 there is in each case a steep transition 35 which is, however, usually not orthogonal to the depth levels 31, 32, 33, 34 and which possesses an angle of between 45° and 90°.

The disclosure is not limited in its execution to the above-mentioned preferred exemplary embodiments. Rather, a number of variants are conceivable which make use of the illustrated solution even in the form of fundamentally different embodiments.

1. An aerodynamic bearing for axial and/or radial mounting of a shaft for a turbocompressor extending along an axis of rotation, the aerodynamic bearing comprising:
a first bearing part denotable as a rotor, and
a second bearing part denotable as a stator with respect to which the first bearing part is rotatable about the axis of rotation,
wherein the first bearing part and/or the second bearing part have a bearing surface facing the respective other bearing part and on which an air cushion for aerodynamic mounting is generatable between the bearing parts,
wherein the bearing surface has a plurality of depressions, each following a predetermined longitudinal profile on the bearing surface and arranged to form a predetermined pattern,
wherein the depressions each have, over their respective longitudinal profiles on the bearing surface, a varying depth which is determined by a depth profile restricted to a predetermined number of discrete depth levels.

2. The aerodynamic bearing according to claim 1,
wherein the depth profile runs at three to twelve depth levels.

3. The aerodynamic bearing according to claim 1,
wherein a respective transition between the depth levels occurs at an angle of less than 45° and in particular at an angle of between 2° and 20°.

4. The aerodynamic bearing according to claim 1,
wherein immediately adjacent depth levels have a distance of between 1 and 20 μm, in particular 2 and 10 μm, from one another.

5. The aerodynamic bearing according to claim 1,
wherein the depth profile is symmetrical or asymmetrical with respect to a centre of the longitudinal profile.

6. The aerodynamic bearing according to claim 1,
wherein the longitudinal profile consists exclusively of rectilinear sections or is curved at least in sections, and/or
wherein the longitudinal profile forms one arrow shape each, so that the depressions each have two sections connected via a bend.

7. The aerodynamic bearing according to claim 1,
wherein the depressions each have, over their respective longitudinal profiles on the bearing surface, a uniform or varying width.

8. The aerodynamic bearing according to claim 1,
wherein the depressions are arranged to form a herringbone pattern and/or overlap at least in sections in a predetermined direction of rotation about the axis of rotation (A).

9. A method of manufacture of an aerodynamic bearing configured according to claim 1,
wherein a continuous depth profile is determined for an optimal pressure distribution on the bearing surface at a maximum rotational speed by simulation and/or calculation, and
wherein the depth profile restricted to the predetermined number of depth levels which approximates the continuous depth profile is determined by interpolation or approximation.

10. The method of manufacture of an aerodynamic bearing according to claim 9,
wherein the depth profile restricted to the predetermined number of depth levels is determined for an optimal pressure distribution on the bearing surface at a maximum rotational speed by simulation and/or calculation.
